(19) United States
(12) Patent Application Publication
(10) Pub. No.: US 2025/0104426 A1
(43) Pub. Date: Mar. 27, 2025

(54) METHOD OF SELECTING HIGH-DEFINITION IMAGE FRAME OF VIDEO BY USING DYNAMIC INFORMATION

(71) Applicant: CUPIX, INC., Gyeonggi-do (KR)

(72) Inventors: SeockHoon BAE, Seoul (KR); Jun Young PARK, Gyeonggi-do (KR); Jin Hwan CHOI, Seoul (KR)

(73) Assignee: CUPIX, INC., Gyeonggi-do (KR)

(21) Appl. No.: 18/898,682

(22) Filed: Sep. 27, 2024

(30) Foreign Application Priority Data
Sep. 27, 2023 (KR) 10-2023-0130396

(51) Int. Cl. G06V 20/40; G06T 7/20

(52) U.S. Cl. CPC G06V 20/46; G06T 7/20

(57) ABSTRACT

Provided is a method of selecting a high-definition image frame of a video by using dynamic information, more particularly, a method of selecting a relatively high-definition image frame from among image frames included in a video by using dynamic information of a camera that has captured the video. The method of selecting a high-definition image frame of a video by using dynamic information has the advantage of quickly and effectively obtaining a large amount of image information from a captured video, and effectively select only image frames with a relatively high definition from among image frames included in the video. In addition, the method of selecting a high-definition image frame of a video by using dynamic information has the advantage of quickly and effectively extracting image frames with a high definition from among image frames included in a video, through a relatively small amount of computation.

### CROSS-REFERENCE TO RELATED APPLICATION

This application is based on and claims priority under 35 U.S.C. § 119 to Korean Patent Application No. 10-2023-0130396, filed on Sep. 27, 2023, in the Korean Intellectual Property Office, the disclosure of which is incorporated by reference herein in its entirety.

### BACKGROUND

### 1. Field

The present disclosure relates to a method of selecting a high-definition image frame of a video by using dynamic information, and more particularly, to a method of selecting a relatively high-definition image frame from among image frames included in a video by using dynamic information of a camera that has captured the video.

### 2. Description of the Related Art

There are a wide variety of services using photo images. Photo images are generally captured in a stationary state and thus have a relatively high definition. Various services using such photo images having a relatively high definition may be provided.

For example, by using a photo image and camera intrinsic parameters, such as a relative position between a projection center and a projection plane of a camera used to capture the photo image, and the size of a projection plane (e.g., a complementary metal-oxide-semiconductor (CMOS) image sensor or a charge-coupled device (CCD) image sensor), the position, orientation, and projection center of each photo image may be calculated. As such, photo images of an object that are captured from different positions or different angles may be used for various purposes, such as to constitute a three-dimensional shape of the object, to calculate the size of the object or the distance to the object, or to provide a 360-degree virtual reality (VR) service.

Using photo images in this way allows for higher-quality services as the number of photos captured from various angles and positions increases. There is an issue in that capturing such a large number of photos requires relatively much time and effort.

A video is composed of a combination of image frames captured continuously over time, which allows for obtaining of a large amount of image information in a relatively short time period.

However, when a cameraman captures a video while moving with a video camera, issues arise where image frames of the captured video deteriorate in definition and thus becomes blurry (an issue of blurriness) depending on the velocity of movement and rotation. Video data captured with a moving camera is likely to have a low definition in image frames that constitute the video. An image with a low definition does not have clear outlines of objects, making it difficult to accurately discern the shape and contours of the objects shown in the image. In addition, when an image containing text has a low definition, it is difficult to identify letters in the image.

When image frames are extracted from data of a video captured in this manner, various constraints arise in practical use due to an issue of deterioration in definition as described above.

For example, when extracting a three-dimensional shape of an object by using image frames of a video, the accuracy of the resulting three-dimensional shape may be compromised. In addition, when calculating the distance between two points in a space by using image frames of a video, the calculation result may be inaccurate.

In addition, when implementing a 360-degree VR video by using image frames of a 360-degree video, displaying an area captured with a low definition on a screen of a display device may result in difficulties in clearly identifying detailed shapes of desired objects or entities such as text, figures, structures, or people. For example, when trying to monitor the progress of a building under construction through a video, it may be difficult to verify whether main structures have been constructed accurately according to the plans, due to the low definition of image frames.

### SUMMARY

Provided is a method of selecting a high-definition image frame of a video by using dynamic information, which may effectively select only image frames having a relatively high definition from among image frames constituting a video, when extracting image frames constituting a video to provide various services.

Additional aspects will be set forth in part in the description which follows and, in part, will be apparent from the description, or may be learned by practice of the presented embodiments of the disclosure.

According to an aspect of an embodiment, a method of selecting a high-definition image frame of a video by using dynamic information, for extracting high-definition image frames from among image frames included in a video by using a mobile device including a camera configured to capture a video and a dynamic sensor configured to measure dynamic information such as an acceleration of the camera includes an operation (a), performed by a video reception module, of receiving and storing a target video in a form of a video captured by the camera of the mobile device, an operation (b), performed by a dynamic information reception module, of receiving and storing, as dynamic information, measurements from the dynamic sensor of the mobile device respectively corresponding to timestamps of the target video, and an operation (c), performed by an image selection module, of selecting, as a selected image frame, at least one image frame corresponding to a timestamp with a relatively small dynamic movement of the camera, from among image frames of the target video.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of a device for implementing an example of a method of selecting a high-definition image frame of a video by using dynamic information, according to the present disclosure;

FIG. 2 is a flowchart for implementing an example of a method of selecting a high-definition image frame of a video by using dynamic information, according to the present disclosure; and

FIG. 3 is a diagram for describing a process of implementing a method of selecting a high-definition image frame of a video by using dynamic information, according to the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. Expressions such as “at least one of,” when preceding a list of elements, modify the entire list of elements and do not modify the individual elements of the list.

Hereinafter, with reference to the accompanying drawings, a method of selecting a high-definition image frame of a video by using dynamic information according to an embodiment of the present disclosure will be described.

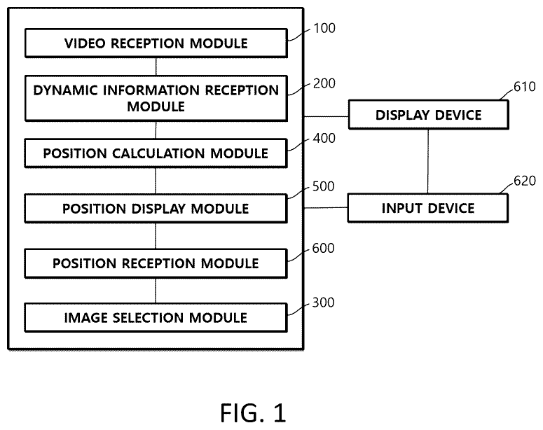

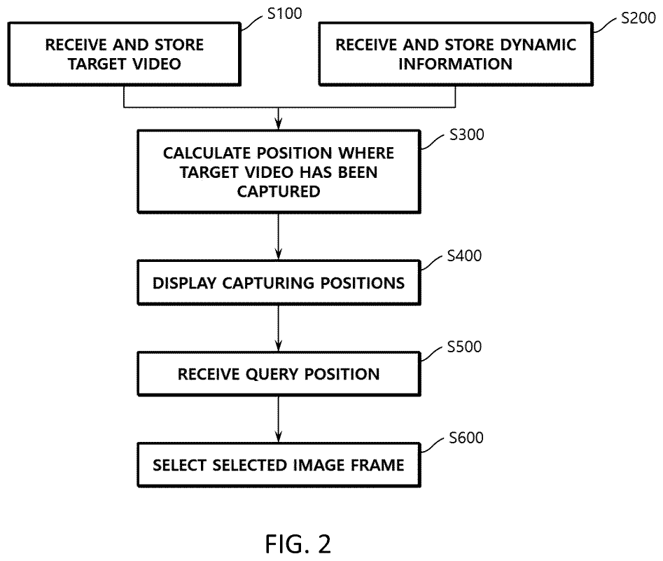

FIG. 1 is a block diagram of a device for implementing an example of a method of selecting a high-definition image frame of a video by using dynamic information, according to the present disclosure, and FIG. 2 is a flowchart for implementing an example of a method of selecting a high-definition image frame of a video by using dynamic information, according to the present disclosure.

Referring to FIG. 1, a device for implementing a method of selecting a high-definition image frame of a video by using dynamic information according to the present disclosure includes a video reception module 100, a dynamic information reception module 200, a position calculation module 400, a position display module 500, and an image selection module 300.

The video reception module 100 receives and stores an input of a target video in the form of a captured video. The target video received by the video reception module 100 may be various types of video composed of image frames that may be rendered in chronological order. In the present embodiment, a video captured by a mobile device such as a mobile phone, or by a 360-degree camera is used as the target video. In some cases, the target video may be a two-dimensional video captured by a mobile phone or a camcorder, a video generated by combining image frames in the shape of a hemisphere to create a 360-degree virtual reality (VR) video, or a video captured with image frames in the shape of a sphere. The target video may be any video data that is captured by using a camera lens and may be reproduced sequentially in chronological order.

The target video is stored with information obtained by recording, over time, dynamic information about a movement of the camera at the time of capturing the target video. Such dynamic information of a camera is measured by various types of sensors, such as an inertial measurement unit (IMU), an acceleration sensor, a geomagnetic sensor, or an angular displacement sensor. In general, such dynamic information is measured by a dynamic sensor installed in a mobile device equipped with a camera. In the present embodiment, a value measured over time by an IMU is used as dynamic information.

The dynamic information reception module 200 receives and stores dynamic information as described above, as a value corresponding to a timestamp of the target video. A timestamp refers to a value corresponding to a time that may be used to map the target video with dynamic information in synchronization with each other.

The position calculation module 400 calculates a position where the target video has been captured, in correspondence to the timestamp of the video by using a measurement from a dynamic sensor received by the dynamic information reception module 200. The position calculation module 400 may calculate the position where the target video has been captured, by using values measured at the time of capturing the target video by sensors such as an IMU or an acceleration sensor, and when necessary, may also calculate the orientation of each image frame of the target video. For example, a change in displacement may be calculated by integrating an acceleration twice, and thus, a value calculated in this manner may be used to determine the position where the corresponding image frame has been captured. The orientation of the camera may also be calculated by using a measurement from an angular velocity sensor such as a gyroscope. In addition to these methods, it is also possible to calculate the position and orientation of each image frame by using methods such as computer vision or structure from motion (SfM). In addition to the above-described methods, various other methods such as visual odometry, simultaneous localization and mapping (SLAM), or machine learning may also be used to calculate the position and orientation of image frames of the target video.

By using the dynamic information, the image selection module 300 selects, as a selected image frame, at least one image frame from among image frames that have been captured at positions with a relatively small dynamic movement of the camera. Because the image frames that have been captured at positions with a relatively small dynamic movement of the camera are likely to be images captured with a high definition, this method may be used to effectively select a high-definition photo image.

There are various methods for the image selection module 300 to select the selected image frame by using dynamic information.

When a user carrying a mobile device captures a target video while staying in one spot without moving, it is highly likely that high-definition image frames are captured, which may be used to select a selected image frame.

For example, when image frames of a target video are captured within a reference area range during a reference time period, the corresponding position may be selected as a static reference position P, and a selected image frame may be selected within a reference radius range centered on the static reference position P. When the reference time period is set to 2 seconds, the reference area range is set to 0.5 m, and the target video is captured for 2 seconds or longer within a radius of 0.5 m, the image selection module 300 selects the corresponding point as the static reference position P. As such, the image selection module 300 selects a selected image frame from among image frames captured within the reference radius range centered on the static reference position P. The image selection module 300 may designate the selected image frame by determining that an image frame has a higher definition as the absolute values of the velocity and the angular velocity corresponding to the image frame are closer to 0.

Alternatively, when measurements in dynamic information for a particular timestamp are within a reference velocity and a reference angular velocity, the image selection module 300 may select, as the static reference position P, a capturing position corresponding to the timestamp. That is, when the reference velocity is set to 10 cm/s and the reference angular velocity is set to 10°/s, the image selection module 300 selects, as the static reference position P, a point at which the absolute values of the velocity and the angular velocity based on dynamic information are within the reference velocity and the reference angular velocity, respectively. When the angular velocity in dynamic information is greater than the reference angular velocity even though the velocity is close to 0, the camera is spinning in place, which is highly likely to result in an image frame with a low definition. Thus, by considering not only the velocity but also the angular velocity, the possibility of selecting an image frame with a high definition increases.

The image selection module 300 may select the selected image frame by determining that, from among image frames captured within the reference radius range (e.g., 0.5 m) centered on the static reference position P, an image frame of which the absolute values of the velocity and the angular velocity are closer to 0 has a higher definition.

The image selection module 300 may use a combination of the above methods, and may select a selected image frame by using another method using dynamic information. In some cases, the image selection module 300 may select a plurality of selected image frames by using dynamic information in the above manner, then compare the definitions of the image frames, and select an image frame with a relatively high definition as the selected image frame.

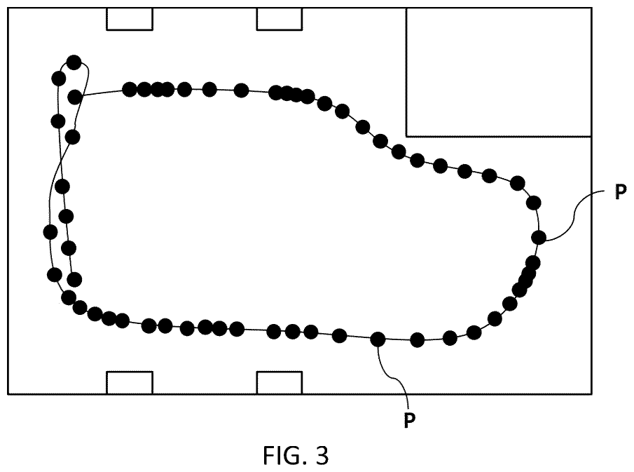

The position display module 500 displays positions where the target video has been captured, on a display device 610 in chronological order. FIG. 3 illustrates an example in which the position display module 500 displays capturing positions of a target video on the display device 610. As illustrated in FIG. 3, the position display module 500 connects positions of respective image frames of a target video captured while the user is moving, and displays them on the display device 610. In some cases, a position corresponding to the static reference position P described above from among the capturing positions of the target video may be indicated distinctly from other positions. In the case of FIG. 3, a position corresponding to the static reference position P is indicated by a bold dot.

A position reception module 600 receives, as a query position, one of the positions where the target video has been captured. In the present embodiment, the user clicks a point corresponding to the query position by using an input device 620 such as a mouse, and the position reception module 600 receives, as the query position, the position corresponding to the clicked point.

As such, when the position reception module 600 receives the query position, the image selection module 300 performs the described-above process of selecting a selected image frame from among image frames of the target video captured within an examination radius range centered on the query position. Here, the examination radius range may be preset to an appropriate value such as 0.5 m.

Hereinafter, a detailed implementation process of a method of selecting a high-definition image frame of a video by using dynamic information according to the present disclosure will be described by using a device configured as described above.

First, the video reception module 100 receives and stores a target video (operation (a); S100). As described above, various types of videos may be used as the target video depending on the purpose and use.

At this time, the dynamic information reception module 200 also receives and stores, as dynamic information, a measurement from a dynamic sensor of the mobile device corresponding to a timestamp of the target video (operation (b); S200). Various measurements may be received as dynamic information depending on the type of the dynamic sensor. In the present embodiment, the dynamic information reception module 200 receives and stores, as dynamic information, a value measured by a widely used IMU.

Next, the position calculation module 400 calculates a position where the target video has been captured, in correspondence to the timestamp of the target video by using a measurement from the dynamic sensor received by the dynamic information reception module 200 (operation (d); S300). As described above, the position calculation module 400 may calculate a position of the target video by using various methods such as visual odometry or SLAM. In some cases, the position calculation module 400 may also calculate the orientation of an image frame as described above. The orientation of the image frame may be displayed on the display device 610 in various manner depending on the case.

The position display module 500 displays capturing positions of image frames calculated by the position calculation module 400 over time, on the display device 610 (operation (e); S400).

In a state in which the capturing positions are displayed on the display device 610 as described above, the position reception module 600 receives a query position selected by the user. That is, when the user clicks, with a mouse, a capturing position of an image frame that the user wants to check, the position reception module 600 receives the corresponding capturing position as a query position (operation (f); S500).

The image selection module 300 selects, as a selected image frame, an image frame with a relatively high definition from among image frames captured within an examination radius range centered on the query position received by the position reception module 600 (operation (c); S600).

Here, the image selection module 300 selects, as the selected image frame, an image frame corresponding to a timestamp with a relatively small movement of the camera, by using the dynamic information received by the dynamic information reception module 200.

The image selection module 300 may use various methods described above to select a selected image frame. When it is confirmed that the position of the camera remains within a reference area range for a reference time period, the corresponding point may be selected as the static reference position P, and the selected image frame may be selected within a reference radius range centered on the static reference position P. The image selection module 300 determines that an image frame has a higher definition as the absolute values of the velocity and the angular velocity are closer to 0, by using static information. In some cases, the image selection module 300 may select a final selected image frame by selecting a plurality of image frames and additionally examining the definitions of the plurality of image frames.

As described above, when measurements in dynamic information for a particular timestamp are within a reference velocity and a reference angular velocity, the image selection module 300 may select, as the static reference position P, a capturing position corresponding to the timestamp. In addition, a selected image frame may be selected within the reference radius range centered on the reference position.

The image selection module 300 may select a selected image frame based on dynamic information in various manners, with a relatively small movement as an essential determination criterion. The image selection module 300 may use the methods described above independently or in combination, and may also select a selected image frame by combining with the methods described above with another method of finding a high-definition image.

Once high-definition image frames are selected by using the method described above, these high-definition image frames may be used for various purposes. It is possible to use them to effectively search for a portion including information such as text, in image frames included in a target video, and recognize the information.

In addition, it is also possible to perform SLAM by using the present disclosure. By calculating only high-definition image frames in conjunction with the intrinsic parameters of a camera that has captured a target video, it is possible to calculate the shape of a three-dimensional object captured in the target video.

As such, according to the present disclosure, a large amount of image information may be obtained quickly and effectively through video capturing, and only high-definition image frames may be extracted from among image frames, and then separately managed, enabling the technical advantages that may be obtained through photography.

When using the method of selecting a high-definition image frame of a video by using dynamic information according to the present disclosure, a user may obtain high-definition image frames by capturing a target video while moving a camera at a relatively slow velocity in an area that requires future review.

In the present disclosure as described above, a method of providing various services by using selected image frames of a target video may be applied to all types of videos, including not only general two-dimensional videos but also 360-degree VR videos. For example, in measuring a three-dimensional distance by using two-dimensional photo images, or in implementing modeling of a three-dimensional shape, high-definition image frames may be extracted from a video instead of photos and used, according to the present disclosure.

Although the present disclosure has been described above with preferred examples, the scope of the present disclosure is not limited to the embodiments described above.

For example, although a case in which operation (f) of receiving a query position is included has been described above as an example, it is also possible to implement, without operation (f), the method of selecting a high-definition image frame of a video by using dynamic information according to the present disclosure.

In addition, although a case in which operation (e) of displaying, on the display device 610, positions where a video has been captured is included has been described above as an example, it is also possible to, in some cases, perform a method of selecting a high-definition image frame of a video by using dynamic information, without operation (e). That is, it is possible to extract only selected image frames and use them for various purposes, without displaying, the display device 610, positions where a video has been captured.

The method of selecting a high-definition image frame of a video by using dynamic information according to the present disclosure has the advantage that it is possible to quickly and effectively obtain a large amount of image information from a captured video, and effectively select only image frames with a relatively high definition from among image frames included in the video. In addition, the method of selecting a high-definition image frame of a video by using dynamic information according to the present disclosure has the advantage that it is possible to quickly and effectively extract image frames with a high definition from among image frames included in a video, through a relatively small amount of computation.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A method of selecting a high-definition image frame of a video by using dynamic information, for extracting high-definition image frames from among image frames included in a video by using a mobile device comprising a camera configured to capture a video and a dynamic sensor configured to measure dynamic information such as an acceleration of the camera, the method comprising:
an operation (a), performed by a video reception module, of receiving and storing a target video in a form of a video captured by the camera of the mobile device;
an operation (b), performed by a dynamic information reception module, of receiving and storing, as dynamic information, measurements from the dynamic sensor of the mobile device respectively corresponding to timestamps of the target video; and
an operation (c), performed by an image selection module, of selecting, as a selected image frame, at least one image frame corresponding to a timestamp with a relatively small dynamic movement of the camera, from among image frames of the target video.

2. The method of claim 1, further comprising an operation (d), performed by a position calculation module, of calculating positions where the target video has been captured, in correspondence to the timestamps of the target video by using the measurements from the dynamic sensor received by the dynamic information reception module,
wherein, in the operation (c), the selected image frame is selected in correspondence to the positions calculated by the position calculation module.

3. The method of claim 2, wherein, in the operation (c), the image selection module selects, as at least one static reference position, a position where the target video has been captured in a static state, by using the measurements from the dynamic sensor, and selects at least one selected image frame from among image frames that have been captured within a reference radius range centered on the at least one static reference position.

4. The method of claim 3, wherein, in the operation (c), based on image frames of the target video having been captured within the reference radius range for a reference time period, the image selection module selects a corresponding position as the static reference position, and selects the selected image frame within the reference radius range.

5. The method of claim 3, wherein, in the operation (c), based on the measurements from the dynamic sensor for a timestamp are within a reference velocity and a reference angular velocity, the image selection module selects, as the static reference position, a capturing position corresponding to the timestamp.

6. The method of claim 2, wherein, in the operation (b), the dynamic information reception module receives, as the dynamic information, measurements from an inertial measurement unit (IMU) as the measurements from the dynamic sensor.

7. The method of claim 1, wherein, in the operation (c), the image selection module compares definitions of a plurality of selected image frames that are selected based on a dynamic movement, and selects, as the final selected image frame, a selected image frame with a relatively high definition.

8. The method of claim 2, further comprising an operation (e), performed by a position display module, of displaying the positions where the target video has been captured, on a display device in chronological order.

9. The method of claim 8, further comprising an operation (f), performed by a position reception module, of receiving, as a query position, one of the positions where the target video has been captured,
wherein, in the operation (c), the image selection module performs a process of selecting the selected image frame from among image frames of the target video that have been captured within an examination radius range centered on the query position.

10. The method of claim 9, wherein, in the operation (f), the query position is received in a manner of designating one of the positions where the target video has been captured, which are displayed on the display device by the operation (e).
